(19) United States
(12) Patent Application Publication
(10) Pub. No.: US 2005/0285087 A1
(43) Pub. Date: Dec. 29, 2005

(54) Jack device

(76) Inventor: Jeffrey N. Stiles, Rio Vista, CA (US)

Correspondence Address: MILLER NASH LLP, 4400 TWO UNION SQUARE, 601 UNION STREET, SEATTLE, WA, 98101-2352, US

(21) Appl. No.: 10/880,065

(22) Filed: Jun. 29, 2004

(51) Int. Cl. B66F 3/24

(52) U.S. Cl. 254/93 H

(57) ABSTRACT

The present invention is directed to an improved jack device, and more specifically, to an improved jack device capable of lifting and lowering an article using hydraulic fluid. The jack device includes a jack body, a receiver, and a base. The receiver includes a handle and an article rest. The jack body includes an exterior segment and an interior segment. The exterior segment includes an outer cap and a lower section, while the interior segment includes an interior tube and a pumping mechanism. In use, the raising and lowering of the outer cap operates the pumping mechanism, which in turn, operates to raise the article rest located on the exterior segment, thereby raising the article to be lifted.

### BACKGROUND OF INVENTION

1. Field of Invention The present invention is directed to an improved jack device, and more

specifically, to an improved jack device capable of raising and lowering an article using fluid.

2. Description of the Related Art

Jack devices are commonly used in industries such as the construction, railroad, and automotive industries. Jack devices are used as a way to raise an article, exert great pressures, and hold an article firmly in position. For example, a jack device may be used to raise a building, and hold the building firmly in its raised position, in order to replace the building's foundation. In another example, a jack device may be used to raise an automobile, and hold the automobile firmly in its raised position, in order to remove and replace a flat tire located on the automobile.

There are a number of different jack devices known in the art. Commonly known jack devices include notched jack devices, screw jack devices, and hydraulic jack devices.

A notched jack device consists of a toothed wheel engaged with a catch. The catch fits into notches usually formed on the toothed wheel. By moving the toothed wheel, the catch simultaneously moves along the notches formed on the toothed wheel, thereby raising or lowering the notched jack device to a desired position. An example of a notched jack device may be found in U.S. Pat. No. 2,260,993 titled Jack, owned by C. S. Johnston (the “'993 Patent”). The notched jack device set forth in the '993 Patent includes a sleeve that may be slidably mounted upon a standard. The sleeve includes means to lift an article. Retaining and lifting latch mechanisms provide the sleeve with the capability to ascend, descend, and engage the standard. The retaining latch mechanism engages the sleeve against the standard, thereby preventing the sleeve from descending the standard. The lifting latch mechanism allows the sleeve to ascend the standard.

Another common type of jack device is a hydraulic jack device. A hydraulic jack device generally utilizes the pressure of hydraulic fluid to lift or lower an article to a desired position. The mechanism whereby hydraulic fluid is supplied to the article lifting mechanism, often referred to as the “ram,” generally varies based on the brand of hydraulic jack device used. Representative examples of hydraulic jack devices may be found in: (i) U.S. Pat. No. 6,450,481 for Toe Jack to Oxtoby; (ii) U.S. Pat. No. 1,964,003 for Hydraulic Jack to J. P. McBride; (iii) U.S. Pat. No. 3,757,523 for Hydraulic Jacks to Resuggan; (iv) U.S. Pat. No. 4,703,916 for Hydraulic Jack Structural Improvements in One-Way Hydraulic Path in Association with Safety Pressure Relief Network to Hung; (v) U.S. Pat. No. 4,641,815 for Hydraulic Jack to Yu; (vi) U.S. Pat. No. 3,806,091 for Hydraulic Jacks to Wride; (vii) U.S. Pat. No. 4,050,674 for Hydraulic Jack to Robbins, deceased et al.; (viii) U.S. Pat. No. 4,202,514 for Hydraulic Jack Device to Chen; and (ix) U.S. Pat. No. 6,027,101 for Bottle Jack and Method to Marx.

A third type of jack device is a screw jack device, which uses a rotating screw mechanism to raise an article. By rotating the screw jack device in either a clockwise or counter-clockwise manner, the screw jack device raises or lowers an article to a desired position. Screw jack devices are often used in connection with household appliances. For example, the bottom of a refrigerator or stove may contain four screw jack devices located on the bottom of the refrigerator or stove. In addition to providing stability to the refrigerator or stove, the screw jack devices allow the refrigerator or stove to be raised simply by rotating the screw jack devices in either a clockwise or counter-clockwise manner.

The are a number of problems associated with the jack devices commonly known in the art. First, notched jack devices generally require the use of an individual's strength in order to operate the notched jack device. Specifically, an individual is often required to operate a mechanism which moves the toothed wheel and the engaged catch. This means that the strength of the individual becomes relevant in determining whether the notched jack device can raise or lower the article. If the article being raised or lowered is heavy or bulky, it may be difficult for the individual, if not impossible, to operate the mechanism necessary to raise and lower the article.

A second problem is that various parts of a jack device may wear down and/or become inoperable. For example, with a notched jack device, the toothed wheel may eventually wear down, either by long-term use of the notched jack device, or through use of the notched jack device in connection with extremely heavy articles. Once the toothed wheel of the notched jack device wears down, it is considered to have “rolled over,” meaning that the catch is unable to engage with the toothed wheel, thereby preventing the lifting or lowering of an article using the notched jack device. The only solution is to either purchase a brand new notched jack device, which may be costly, or purchase a replacement toothed wheel, which may be impossible, depending on the notched jack device manufacturer.

A third problem associated with jack devices commonly known in the art is that they are not easily transportable. Jack devices are often manufactured to lift heavy or bulky articles such as houses. As a result, some jack devices are so heavy and bulky themselves, that they are unable to be moved or transported by an individual. Instead, an individual is required to use a jack transportation device, such as wheels, pulleys, or carts, in order to move the jack device. Attaching transportation devices to a jack device is often inconvenient, and if the jack device is being transported over rocky or hilly terrain, the transportation devices may be useless.

A fourth problem is that most jack devices are unable to be used on any surface other than a level surface. These type of jack devices are therefore inefficient in situations where the article to be lifted is resting on rocky or hilly terrain. Additionally, most jack devices require a certain amount of clearance under the article in order to place the jack device underneath the article. If the article does not provide for a sufficient amount of clearance, the jack device cannot be used to lift or lower the article.

The above-listed problems illustrate a clear need in the industry for a jack device that is portable, light-weight, includes easily replaceable parts, can be operated without requiring a significant amount of individual strength, is easy and inexpensive to maintain, and can be operated on an unleveled surface without requiring a large amount of clearance under the article.

### BRIEF SUMMARY OF THE INVENTION

The present invention is directed to an improved jack device, and more specifically, to an improved jack device capable of lifting and lowering an article using hydraulic fluid.

The present invention is directed to an improved jack device, and more specifically, to an improved jack device capable of lifting and lowering an article using hydraulic fluid. The jack device includes a jack body, a receiver, and a base. The receiver includes a handle and an article rest. The jack body includes an exterior segment and an interior segment. The exterior segment includes an outer cap and a lower section, while the interior segment includes an interior tube and a pumping mechanism. In use, the raising and lowering of the outer cap operates a pumping mechanism, which in turn, operates to raise the article rest located on the exterior segment, and thereby, the article to be lifted.

The foregoing and other objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

FIG. 1 is a drawing of a perspective view of an exemplary embodiment of a jack device of the present invention.

FIG. 2 is a drawing of an enlarged side view of a receiver and base of the exemplary embodiment of the jack device shown in FIG. 1.

FIG. 3 is a drawing of an enlarged perspective view of an alternative exemplary embodiment of receiver that may be used with the exemplary embodiment of the jack device shown in FIG. 1.

FIG. 4 is a drawing of an exploded view of an exemplary embodiment of an interior segment and exterior segment of a jack device of the present invention.

FIG. 5 is a drawing of an exploded view of a plug mechanism that may be used with the exemplary embodiment of the interior segment of the jack device shown in FIG. 4.

FIG. 6 is a drawing of an exploded view of a sealing ring that may be used with the exemplary embodiment of the interior segment of the jack device shown in FIG. 4.

FIG. 7 is a drawing of an exploded view of a piston set that may be used with the exemplary embodiment of the interior segment of the jack device shown in FIG. 4.

FIG. 8 is a drawing of an interior view of a first piece valve of the piston set shown in FIG. 7.

FIG. 9 is a drawing of an exploded view of a u-cup mechanism that may be used with the exemplary embodiment of the interior segment of the jack device shown in FIG. 4.

FIG. 10 is a cross-sectional view of the assembled interior segment and exterior segment of the jack device shown in FIG. 4.

### DETAILED DESCRIPTION OF THE INVENTION

The present invention is directed to an improved jack device 100, and more specifically, to an improved jack device 100 capable of raising and lowering an article using fluid. Preferably, the jack device 100 of the present invention is portable, light-weight, includes easily replaceable parts, can be operated without requiring a significant amount of individual strength, and can be operated on an unlevel or uneven surface without requiring a large amount of clearance under the article.

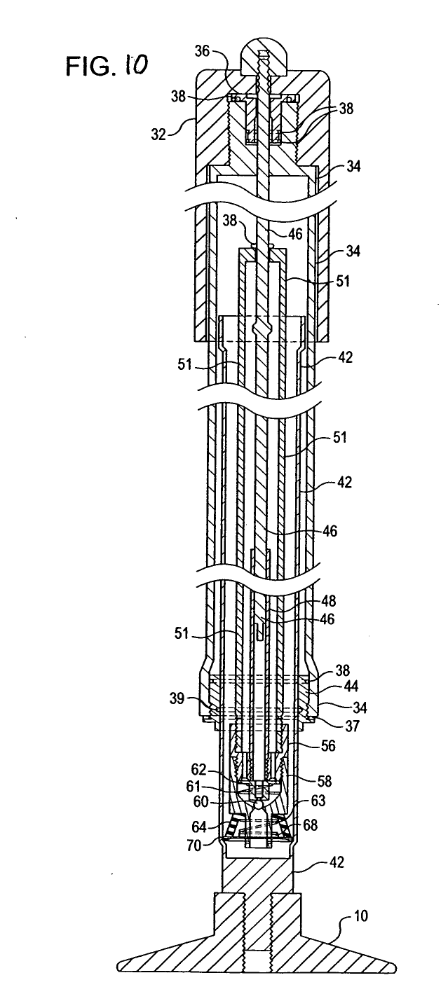

FIGS. 1-10 detail an exemplary embodiment of the jack device 100 of the present invention including several variations thereof. Generally, the jack device 100 includes a jack body 30, a receiver 20, and a base 10.

For purposes of this detailed description, the terms “upper,” “bottom” and “lower” are to be defined as commonly used in the art. The terms “upper,” “bottom” and “lower” may also be defined in relation to the jack device 100 of the present invention as it stands in an upright position. Further, for purposes of this detailed description, the term “connected” means operably associated with, permanently connected, removably connected, interchangeably connected, connected by way of a threaded connection, connected by a snap mechanism, directly connected, indirectly connected, or any combination thereof.

I. Base

The base 10 of the invention, shown in the exemplary preferred embodiments illustrated in FIGS. 1-2, 4, and 10, defines the bottom portion of the jack device 100 of the present invention.

The base 10 provides the mechanism by which the jack device 100 of the present invention may be attached, secured, or placed on a desired location. The desired location may be the ground, paved surface, floor, or other similar structure or surface.

If the desired location where the jack device 100 will be used is constant, the base 10 may be manufactured in any size or shape to fit the desired location. Specifically, the base 10 may be designed to fit around obstacles or to conform to size restrictions or requirements presented by the desired location where the jack device 100 is to be used.

If the desired location where the jack device 100 will be used is not constant, there are various preferred embodiments of the base 10 that may be used in connection with the jack device 100 of the present invention, including a surface structure embodiment 10′ and a modular base embodiment 10″.

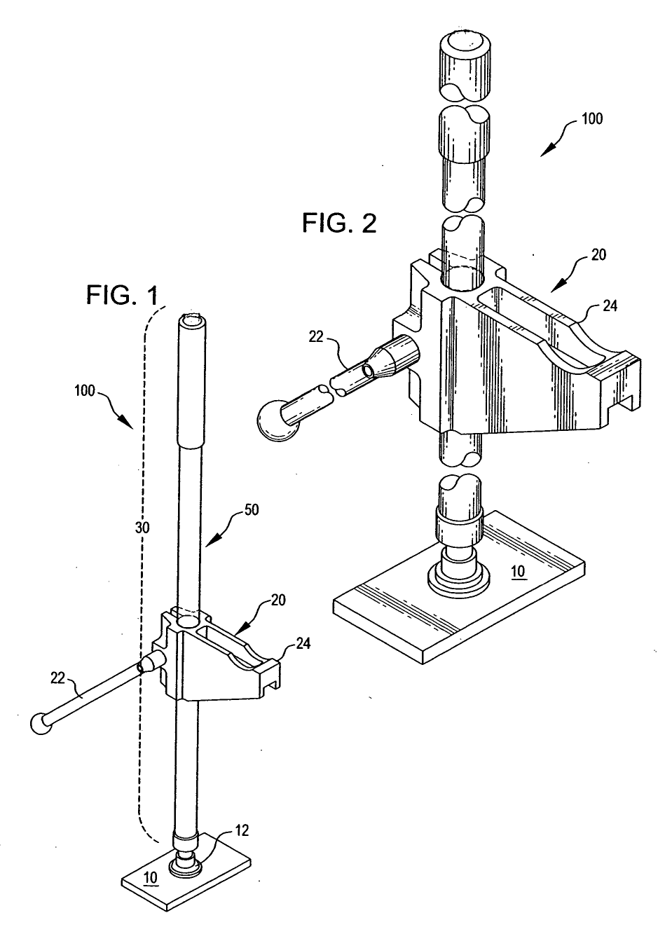

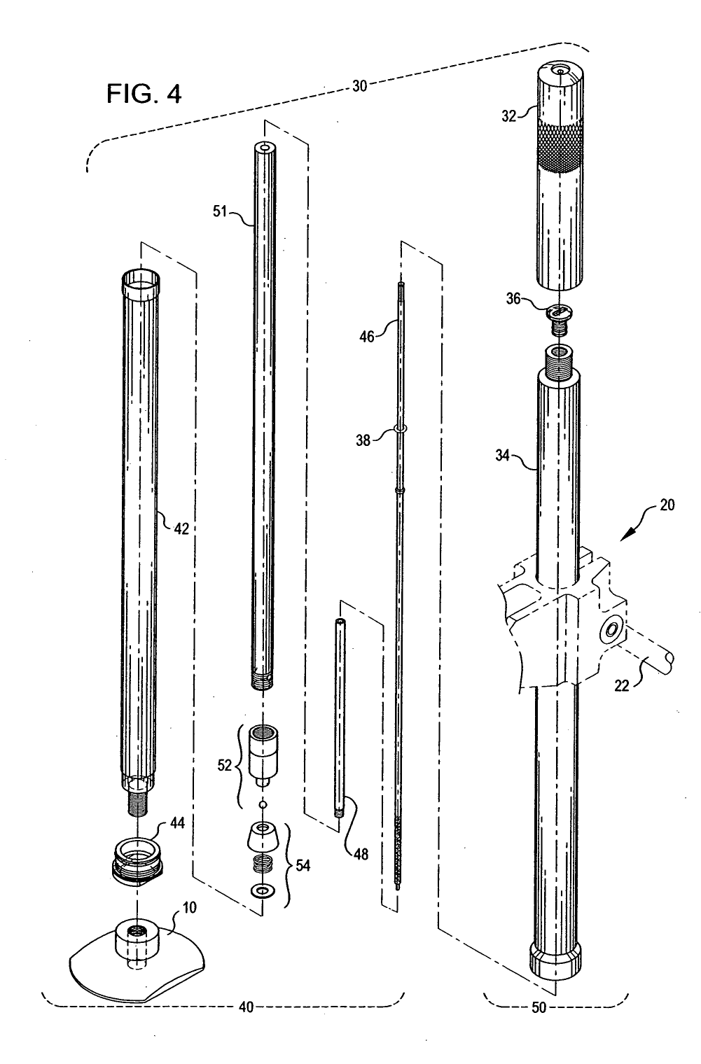

In the surface structure embodiment 10′, which is shown in FIGS. 1-2 and 4, the base 10′ is a surface structure capable of anchoring the jack device 100 in a specifically shaped desired location (“surface structure embodiment”). The surface structure embodiment 10′ may be manufactured in any shape, including, for example, in the shape of a square, circle, rectangle, or triangle. The base 10′ shown in FIGS. 1 and 2 is shaped as a rectangle. The base 10′ shown in FIG. 4 has four-sides, with a first and second side having a straight edge, and a third and fourth side having an arc-shaped side. In an optional embodiment, the surface structure embodiment 10′ may be custom-made to conform to size or obstacle restrictions or requirements of the desired location where the jack device 100 is to be used.

In the modular base embodiment 10″, the base 10″ includes interchangeable base elements. With the modular base embodiment 10″, the jack body 30 of the jack device 100 is capable of connecting with a variety of differently shaped bases 10″. The purpose of the modular base embodiment 10″ is to allow the jack device 100 to be attached or anchored to various locations using the same jack device 100, regardless of obstacles or size restrictions or requirements.

For example, using the modular base embodiment 10″, the jack device 100 of the present invention may be used to lift a railroad car when there is a railroad tie between the ground and the railroad car. With the modular base embodiment 10″, the base 10″ of the jack device 100 could be coupled with a base 10″ that is coupled with the rectangular shape of the railroad tie.

Regardless of the base embodiment used in connection with the present invention, it is preferred that the base 10 be capable of connecting with the jack body 30 of the jack device 100. In a first embodiment, the base 10 is permanently connected to the jack body 30. In a second embodiment, the base 10 is removably connected with the jack body 30 using a snap mechanism. The snap mechanism allows the jack body 30 to connect to, and be removed from, the base 10 of the jack device 100. In a third embodiment, the base 10 and the jack body 30 may be connected using a threaded connection, as shown in FIG. 4. In a fourth embodiment, preferably used if the modular base embodiment 10″ is used in connection with the jack device 100 of the present invention, the base 10″ is interchangeably connected with the jack body 30. An interchangeable connection preferably allows various-shaped bases 10″ to be connected with, and be disconnected from, the jack body 30.

As shown in FIG. 4 the base 10 is connected to the jack body 30, and preferably, the interior segment 40 of the jack body 30. In a first embodiment, the base 10 is permanently connected with the interior segment 40 of the jack body 30 by welding the base 10 to the interior segment 40 of the jack body 30. In a second embodiment, the base 10 is connected with the interior segment 40 of the jack body 30 using a connectable mechanism. The connectable mechanism allows the base 10 to connect and disconnect from the jack body 30. The connectable mechanism further allows the modular base embodiment 10″ to be used in connection with the present invention.

An optional swivel foot 12 may be used in connection with the base 10. The swivel foot 12 is shown in FIG. 1, and preferably provides a connection mechanism that allows the base 10 of the jack device 100 to connect with the jack body 30. The optional swivel foot 12 preferably further provides a rotating mechanism which allows the jack body 30 to rotate around the axis of the swivel foot 12. The option swivel foot 12 may be advantageous when using the jack device 100 of the present invention in connection with surfaces other than flat surfaces. For example, an automobile may get a flat tire, thereby requiring a jack device 100 to raise the automobile in order for the tire to be fixed or replaced. If, for any reason, the automobile has stopped in a rocky or hilly location, it may be impossible, due to clearance and surface issues underneath the automobile, to place the jack device 100 directly under the automobile. However, by using the optional swivel foot 12, the base 10 of the jack device 100 of the present invention may be located adjacent to the automobile, and the jack body 30 may be rotated upon the swivel foot 12 so that the receiver 20 of the jack device 100 is able to be located under the article to be lifted, which in this example, is the automobile.

The base 10 is preferably manufactured from a steel and aluminum mix. The base 10 may also be manufactured from elements such as carbon fiber, cast iron, steel, any durable material, or any combination thereof.

II. Receiver

As shown in FIGS. 1-4, preferably connected to the jack body 30, and preferably, the exterior segment 50 of the jack body 30 is a receiver 20. The receiver 20 provides a location on the jack device 100 where the article to be raised or lowered may be positioned.

Preferably, the receiver 20 is manufactured from a steel and aluminum mix. The receiver 20 may also be manufactured from elements such as carbon fiber, cast iron, steel, any durable material, or any combination thereof. It is preferred that the receiver 20 be manufactured from a material, or combination of materials, that differ from the material of the exterior segment 40 of the jack body 30. This difference of materials between the exterior segment 50 of the jack body 30 and the receiver 20 will optimally prevent the slipping of the receiver 20 down the exterior segment 50 of the jack body 30.

The receiver 20 preferably includes an article rest 24 and an optional handle 22. The article rest 24 is connected to the receiver 20 and provides a physical location upon which the article to be raised or lowered may be positioned (the “lifting location”). In a first exemplary embodiment of the article rest 24, shown in FIGS. 1 and 2, the lifting location is u-shaped. The u-shaped lifting location may be used to lift any article capable of being positioned on a u-shaped location, such as, for example, the bumper of an automobile.

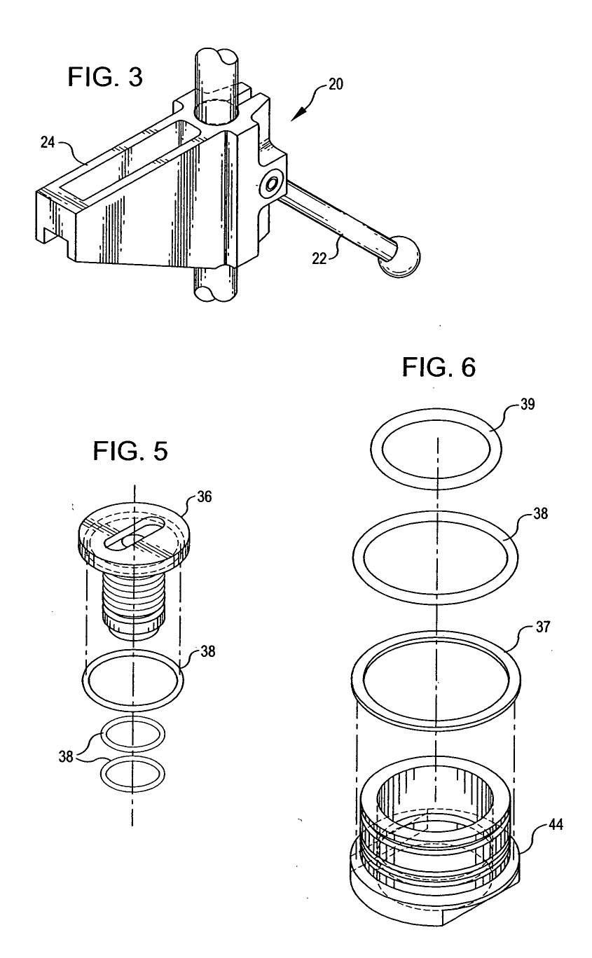

FIG. 3 shows a second exemplary embodiment of the article rest 24, which includes a flat lifting location. The flat lifting location may be used to lift any article capable of being positioned on a flat surface, such as, for example, a refrigerator.

In a third exemplary embodiment of the article rest 24 of the present invention, there are provided a plurality of interchangeable article rests 24. Preferably, each of the interchangeable article rests 24 contain a differently-shaped lifting location. The plurality of article rests 24 may be manufactured as part of various receivers 20, or the receiver 20 may be manufactured with an attachment mechanism whereby the plurality of interchangeable article rests 24 may be interchangeably attached to the receiver 20. Using interchangeable article rests 24 allow the jack device 100 to be used in connection with a plurality of differently shaped articles such as refrigerators, houses, and automobiles.

As is apparent from the foregoing, the jack device 100 of the present invention may be used to lift, essentially, any article. It is usually difficult, if not impossible, to determine the shape of the article, where the article will be located, and the amount of clearance between the article and the surface upon which it is located. For example, the clearance between a refrigerator and the kitchen floor is usually less than the clearance between an automobile and the ground. As a result, it is important that the receiver 20 be capable of moving up and down, and ultimately connecting with, the jack body 30 so that the article rest 24 may be positioned under articles of varying clearance heights.

The receiver 20 is connected to the jack body 30, and preferably, to the exterior segment 50 of the jack body 30. FIGS. 1-4 shows a first exemplary embodiment for connecting the receiver 20 to the exterior segment 50 of the jack body 30. The article rest 24 in the shown embodiment includes opposing ends that form a hollow center. The jack body 30 may be inserted into the hollow center of the article rest 24. As shown, the article rest 24 does not fully enclose the jack body 30. Optional handle 22 may then be inserted through the article rest 24. An optional handle 22 is shown in FIGS. 1-4, and operates to connect the opposing ends of the article rest 24 with the exterior segment 50 of the jack body 30. By rotating the optional handle 22, the article rest 24 may be loosened, thereby allowing the receiver 20 to raise or lower on the exterior segment 50 of the jack body 30. Upon placement of the article on the lifting location of the article rest 24, the optional handle 22 may then be rotated, thereby tightening, and ultimately connecting, the receiver 20 with the exterior segment 50 of the jack body 30. In a second preferred embodiment for connecting the receiver 20 with the exterior segment 50 of the jack body 30, the receiver 20 does not include the optional handle 22. Instead, the receiver 20 includes an attachment mechanism, such as a screw and clasp mechanism, which allows the receiver 20 to move up and down the jack body 30. In a third preferred embodiment, the receiver 20 is permanently connected or welded to the exterior segment 50 of the jack body 30 and is incapable of moving up and down the exterior segment 50 of the jack body 30.

While FIGS. 1-4 show a jack device 100 including one receiver 20, it should be understood that the jack device 100 of the present invention may include at least two receivers 20. The at least two receivers 20 would be optimal in situations where the article to be lifted includes more than one lifting location. The at least two receivers 20 could also be used in situations where there are at least two articles to be lifted. By locating the at least two receivers 20 at least two different locations on the jack body 30, the at least two articles could be lifted simultaneous by the jack device 100.

III. Jack Body

As shown in FIGS. 1 and 4, extending vertically from the base 10 is a jack body 30. The jack body 30 may be cylindrically shaped and includes an exterior segment 50 and an interior segment 40. The exterior segment 50 is preferably housed around the interior segment 40. Exemplary preferred embodiments of the exterior segment 50 of the jack body 30 are illustrated in FIGS. 1 and 4, while an exemplary preferred embodiment of the interior segment 40 of the jack body 30 is illustrated in FIG. 4.

A. Exterior Segment

The exterior segment 50 of the jack body 30 is shown in FIGS. 1 and 4. The exterior segment 50 of the jack body 30 is preferably comprised of an outer cap 32 and a lower section 34.

Preferably, the exterior segment 50 of the jack body 30 is manufactured from a steel and aluminum mix. The exterior segment 50 of the jack body 30 may also be manufactured from elements such as carbon fiber, cast iron, steel, or any combination thereof. It is preferred that the exterior segment 50 of the jack body 30 be manufactured from a material, or combination of materials, that differ from the material of the receiver 20. This difference of materials between the exterior segment 50 of the jack body 30 and the receiver 20 will optimally prevent the slipping of the receiver 20 down the jack body 30.

Preferably, the lower section 34 of the jack body 30 connects with the base 10. Optionally, and as shown in FIG. 4, the lower section 34 may connect with the base 10 via a sealing ring 44 located around an interior tube 42.

The lower section 34 also connects with the interior of the outer cap 32. Preferably, the outer cap 32 defines the top of the jack device 100. As shown in FIG. 4, the outer cap 32 may be a cylindrical structure having a substantially closed top.

It is preferred that the outer cap 32 include a first connection point and a second connection point (not shown). The outer cap 32 may then connect with the lower section 34 via the first connection point, while the pump rod 46 of the interior segment 40 may connect with the outer cap 32 via the second threaded connection. Optionally, the first and second connection points may be threaded connections.

B. Interior Segment

The interior segment 40 of the jack device 100 is shown in FIG. 4. The interior segment 40 of the jack body 30 may be accessed by disconnecting the outer cap 32 from the lower section 34 of the jack body 30, and removing an optional plug mechanism 36 from the lower section 34. The optional plug mechanism 36 preferably operates to keep the fluid used in connection with the jack device 100 within the lower section 34 of the jack body 30.

Preferably, the optional plug mechanism 36 includes at least one exterior o-ring 38. The purpose of the at least one exterior o-ring 38 is to provide for secured sealing of the fluid within the lower section 34. FIG. 5 shows an exemplary embodiment of the optional plug mechanism 36 having three o-rings 38.

The interior segment 40 of the jack device 100 further includes an interior tube 42 and a pumping mechanism. The interior tube 42 is housed around the pumping mechanism, which is further discussed below.

The interior tube 42 is preferably connected to the base 10 of the jack device 100. FIG. 4 shows an exemplary embodiment of the interior tube 42, wherein the interior tube 42 is connected to the base 10 via a sealing ring 44. If the sealing ring 44 is used to connect the interior tube 42 to the base 10, it is preferred that a plastic outer ring 37 be located between the sealing ring 44 and the interior tube 42. It is further preferred that at least one exterior o-ring 38 be located above the plastic outer ring 37, and that an interior o-ring 39 be inserted within the sealing ring 44. The purpose of plastic outer ring 37, exterior o-ring 38 and interior o-ring 39 is to seal fluid within the interior segment 40 of the jack device 100.

Housed within the interior tube 42 is the pumping mechanism. The pumping mechanism includes a pump rod 46, a fluid tube 48, an outer rod 51, a piston set 52, and a u-cup mechanism 54.

As shown in FIG. 4, the outer rod 51 surrounds the fluid tube 48. In turn, the fluid tube 48 surrounds the pump rod 46. The outer rod 51 is preferably a tubular structure having a hole which is located at the top of the outer rod 51. The pump rod 46 may be positioned through the hole located at the top of the outer rod 51. As further discussed below, the bottom of the outer rod 51 preferably contains a mechanism for connecting with piston set 52.

Housed around the pump rod 46 is a fluid tube 48. The fluid tube 48 accommodates the fluid used in connection with the invention. Preferably, the liquid accommodated within the fluid tube 48 is fluid commonly known in the art as being used in connection with hydraulic jacks. Acceptable liquids may include, but are not limited to, shock fluid, brake fluid, hydraulic oil, motor oil, or any combination thereof.

Preferably positioned around the top of the fluid tube 48 is an exterior o-ring 38. The exterior o-ring 38 may be one commonly known in the art. The exterior o-ring 38 operates to prevent fluid from seeping out the top of the fluid tube 48 by creating a seal between the fluid tube 48 and the pump rod 46 contained within, and extending from, the fluid tube 48.

Housed within the fluid tube 48 and outer rod 51 is pump rod 46. The top pump rod 46 preferably contains a connection mechanism whereby the pump rod 46 may connect with the outer cap 32. If the pump rod 46 is connected with the outer cap 32, then raising and lowering the outer cap 32 will operate to simultaneously raise or lower the pump rod 46. The bottom of the pump rod 46 is tapered such that the circumference of the bottom of the pump rod is less than the circumference of the remaining portion of the pump rod 46.

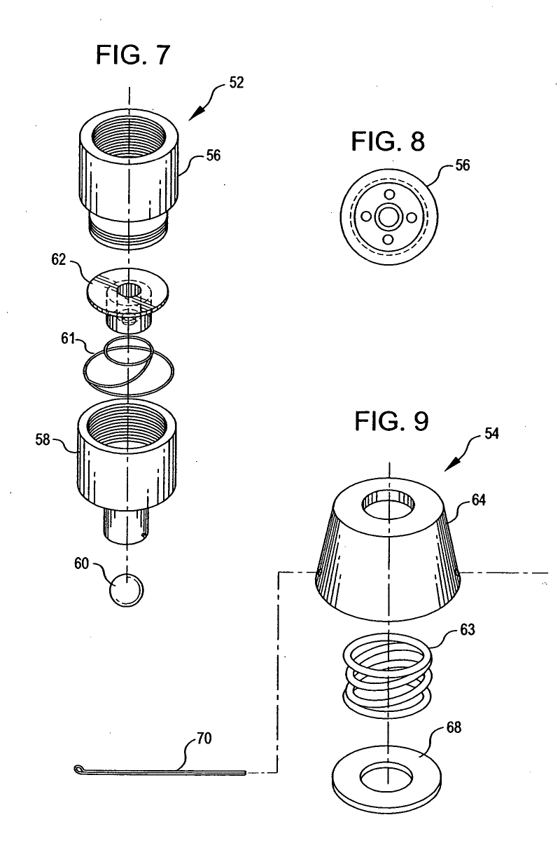

As shown in FIG. 4, a piston set 52 is connected to the outer rod 51. As shown in FIG. 7, the piston set 52 includes a first piece valve 56 and a second piece valve 58, a watch spring with plate 62, and a ball 60. The first piece valve 56 of the piston set 52, is located above the second piece valve 58. The bottom of the first piece valve 56 is connected to the second piece valve 58. In a preferred embodiment, the first piece valve 56 includes an exterior threaded connection which connects to an interior threaded connection located on the top of the second piece valve 58.

The top of the first piece valve 56 preferably connects to the outer rod 51. In a preferred embodiment, the first piece valve 56 includes an interior threaded connection, and is connected to an exterior threaded connection located on the outer rod 51.

The interior of the first piece valve 56 further includes an opening. The opening of the first piece valve 56 provides a mechanism by which the fluid tube 48 may be connected to the first piece valve 56. In a preferred embodiment, the first piece valve 56 contains an interior threaded connection which connects to an exterior threaded connection located on the bottom of the fluid tube 48. The fluid tube 48 houses the pump rod 46, and thus, when the first piece valve 56 is connected with the fluid tube 48, the pump rod 46 is slidably located through the opening of the first piece valve 56.

The interior of the first piece valve 56 may further includes at least one hole. The at least one hole preferably surrounds the opening of the first piece valve 56. In a preferred embodiment, the interior of the first piece valve 56 includes four holes.

Located between the first piece valve 56 and the second piece valve 58 is a watch spring 61 and plate 62. The purpose of the watch spring 61 and plate 62 is to hold and release the plate 62 against the inner surface of the piston set 52 to prevent and allow the fluid from passing through the piston set 52.

As previously discussed, the second piece valve 58 of the piston set 52, shown in FIG. 7, is connected to the first piece valve 56 of the piston set 52. Preferably, the interior of the second piece valve 58 includes a opening. The opening of the second piece valve 58 corresponds to the opening of the first piece valve 56, thereby allowing the pump rod to slidably locate through the openings of both the first piece valve 56 and second piece valve 58.

As shown in FIG. 7, the bottom of the second piece valve 58 has a circumference smaller than the top of the second piece valve 58. Similarly, the bottom of the pump rod 46 has a circumference smaller than the remaining portion of the pump rod 46. Thus, when the bottom of the pump rod 46 is located within the interior of the second piece valve 58 of the piston set 52, it is prevented from exiting the piston set 52.

Located below the pump rod 46, and within the bottom of the second piece valve 58, is a ball 60. The purpose of the ball 60 is further discussed below.

Surrounding the bottom of the piston set 52 is a u-cup mechanism 54. The u-cup mechanism 54 of the present invention preferably includes a spring 62, u-cup 64 and a washer 68. As shown in FIG. 9, the u-cup 64 abuts the second piece valve 58. The spring 62 may then be loaded into the u-cup 64. Preferably placed over the spring 62 is a washer 68.

The bottom of the second piece valve 58 is connected to the u-cup mechanism 54 via a connection mechanism such as a cotter pin 70. If a cotter pin 70 is used as the connection mechanism, the cotter pin 70 is preferably inserted through the two openings located on the u-cup 64 and shown in FIG. 9. The cotter pin 70 preferably operates to maintain the connection between the u-cup mechanism 54 and the bottom of the piston set 52, and specifically, the second piece valve 58. The cotter pin 70 further operates to keep the spring 62 and washer contained within the u-cup 64.

IV. Use

To lift an article using the jack device 100 of the present invention, the base 10 and receiver 20 are connected to the jack body 30. Depending on the exemplary embodiment used in connection with lifting the article, the jack device 100 is either placed next to, or directly under, the article to be lifted. If there is a sufficient amount of clearance underneath the article to be lifted in which to place the jack device 100, then the jack device 100 may be located directly under the article to be raised. If there is not enough clearance to place the jack device 100 under the article to be lifted, then the optional swivel foot 12 of the jack device 100 may be utilized. As previously stated, the swivel foot 12 provides an optional rotating mechanism which allows the jack body 30 to rotate around the axis of the swivel foot 12. The optional swivel foot 12 preferably allows the jack device 100 to be placed adjacent to the article to be lifted, instead of directly underneath it.

The handle 22 is loosened by turning the handle 22 in a clockwise direction. The loosening of the handle 22 in turn preferably loosens the article rest 24 of the receiver 20 on the jack body 30. The article rest 24 may then be adjusted so that it is located directly under, and in contact with, the article to be lifted. The handle 22 is then rotated in the direction necessary to connect the article rest 24, and thereby the receiver 20, to the jack body 30.

After placing the article on the lifting location of article rest 24, the outer cap 32 disconnects from the lower section 34 so that it is capable of being raised and lowered. By raising and lowering the outer cap 32, a pumping action is commenced which operates to lift or lower the article using the jack device 100 of the present invention.

Specifically, when the outer cap 32 is raised, the pump rod 46, which, as previously discussed, is connected to the outer cap 32, is simultaneously raised. The pump rod 46 is raised through the interior segment 40, and specifically, through the u-cup mechanism 46, the piston set 52 and the fluid tube 48. As the pump rod 46 is raised beyond the bottom of the fluid tube 48, an opening is provided at the bottom of the fluid tube 48. This opening at the bottom of the fluid tube 48 allows for the release of the fluid contained in the fluid tube 48. The fluid flows down into the piston set 52.

Additionally, as the pump rod 46 is raised through the u-cup mechanism 54, the ball 60 raises through the interior segment 40 and into the bottom of the second valve 58, thereby operating to obstruct the opening located at the bottom of the second piece valve 58.

Further, as the pump rod 46 is raised through the piston set 52, plate 62 is drawn away from the first piece valve 56. This allows fluid to enter the fluid tube 48, thereby, essentially “loading” the fluid tube. When the pump rod is raised to its maximum height, the plate 62 reseals against the first piece valve 56, thereby preventing further fluid to be drawn in to fluid tube 48.

After the outer cap 32 has been raised to its maximum height, it is preferably lowered. When the outer cap 32 is lowered, the pump rod 46, which is preferably connected to the outer cap 32, is simultaneously lowered.

When the pump rod 46 passes through the bottom of the fluid tube 48, it effectively closes off the opening at the bottom of the fluid tube 48, thereby stopping the flow of fluid from the bottom of the fluid tube 48. The pump rod 46 then passes through the hole of the first piece valve 56 and the hole of the second piece valve 58, thereby operating to push the ball 60 and the released fluid, down and out of the piston set 52.

The pressure of the fluid against the bottom of the interior segment 40 of the jack device 100 optimally raises the interior segment 40 of the jack device, including the piston set 54 and the u-cup mechanism 54. When the interior segment 40 is raised, u-cup mechanism 54 expands and u-cup 64 forms a hydraulic seal against the interior segment 40 of the jack device 100, thereby holding the jack device 100 in its raised position.

The outer cap 32 may then be raised or moved to a stationary position. Preferably, ball 60 re-enters the bottom of the second piece valve 58 of the piston set 52, which in turn, prevents fluid from entering the lower portion of the device 100. These movements further allow the jack device 100 to hold in its raised position.

To release the jack device 100 from the desired position, the outer cap 32 is preferably screwed to a release point, which is (if a threaded connection mechanism is used) preferably the point when the outer cap 32 is screwed between the first and last threads of the exterior segment 50 of the jack body 30. This release point may vary based on the location of the plug mechanism 36 located at the top of the interior tube 42. By screwing the outer cap 32 to a preferred release point, the pump rod 46 may be lowered, which in turn, pushes the ball 60 down through the piston set 52. Fluid is thereby released, which in turn releases the u-cup mechanism 54 and piston set 52. Fluid may then re-enter the piston set 52 and back into the fluid tube 48.

The terms and expressions used in the foregoing specification are used as terms of description and not of limitation, and are not intended to exclude equivalents of the features shown and described or portions of them. The scope of the invention is defined and limited only by the claims that follow.

1. A jack device, said jack device comprising:
(a) a jack body;
(b) a base, said base connected to said jack body; and
(c) at least one receiver, said at least one receiver connected to said jack body.

2. The jack device of claim 1, said selected from a group consisting of:
(a) a surface structure embodiment; and
(b) a modular base embodiment.

3. The jack device of claim 1, said base further including a swivel foot mechanism.

4. The jack device of claim 1, wherein said base is connected with an interior segment of said jack body.

5. The jack device of claim 1, wherein said base is manufactured from a material selected from a group consisting of:
(a) a steel and aluminum mix;
(b) carbon fiber;
(c) cast iron;
(d) steel;
(e) any durable material; and
(f) any combination thereof.

6. The jack device of claim 1, wherein said receiver is manufactured from a material selected from a group consisting of:
(a) a steel and aluminum mix;
(b) carbon fiber;
(c) cast iron;
(d) steel;
(e) any durable material; and
(e) any combination thereof.

7. The jack device of claim 1, wherein said jack device is manufactured from a material selected from a group consisting of:
(a) a steel and aluminum mix;
(b) carbon fiber;
(c) cast iron;
(d) steel;
(e) any durable material; and
(e) any combination thereof.

8. The jack device of claim 1, wherein said receiver further includes an article rest connected to said receiver.

9. The jack device of claim 8, wherein said receiver further includes a handle inserted through said article rest.

10. The jack device of claim 8, wherein said article rest includes a lifting location, said lifting location manufactured in a shape selected from a group consisting of:
(a) a u-shape;
(b) a flat shape; and
(c) any other shape capable of holding an article.

11. The jack device of claim 1, wherein said jack body further includes:
(a) an exterior segment;
(b) an interior segment; and
(c) said exterior segment housed around said interior segment.

12. The jack device of claim 11, said exterior segment further includes:
(a) an outer cap;
(b) a lower section; and
(c) said outer cap located above said lower section.

13. The jack device of claim 11, said interior segment further including:
(a) an interior tube;
(b) a pumping mechanism; and
(c) said interior tube housed around said pumping mechanism.

14. The jack device of claim 13, wherein said interior tube is connected to said base.

15. The jack device of claim 13, said pumping mechanism further including:
(a) an outer rod;
(b) a fluid tube, said outer rod surrounding said fluid tube;
(c) a pump rod, said fluid tube surrounding said pump rod;
(d) a piston set, said piston set connected to said outer rod; and
(e) and a u-cup mechanism, said u-cup mechanism surrounding a portion of said piston set.

16. The jack device of claim 15, said fluid tube accommodating fluid from a group consisting of:
(a) shock fluid;
(b) brake fluid;
(c) hydraulic oil;
(d) motor oil; and
(e) any combination thereof.

17. The jack device of claim 15, said piston set further including:
(a) a first piece valve;
(b) a second piece valve, said second piece valve connected to said first piece valve;
(c) a watch spring with plate, said watch spring with plate located between said first piece valve and said second piece valve; and
(d) a ball, said ball located within said second piece valve.

18. The jack device of claim 15, said u-cup mechanism further including:
(a) a u-cup;
(b) a spring;
(c) a washer;
(d) said spring and washer loaded into said u-cup.

19. The jack device of claim 18, said u-cup mechanism further including a cotter pin, said cotter pin inserted through at least two openings located on said u-cup.

20. A method for lifting an article, said method comprising:
(a) placing a jack device under an article, said jack device including:
an exterior segment, said exterior segment including:
an outer cap; and
a lower section, said outer cap located above said lower section.
an interior segment, said interior segment including:
an interior tube;
a pumping mechanism, said interior tube housed around said pumping mechanism; and
said pumping mechanism further including an outer rod, a fluid tube, said outer rod surrounding said fluid tube, a pump rod, said fluid tube surrounding said pump rod, a piston set, said piston set connected to said outer rod, and a u-cup mechanism, said u-cup mechanism surrounding a portion of said piston set.
(b) positioning said article on said article rest, said article rest connected to said exterior segment; and
(c) raising and lowering said outer cap, thereby lifting said article.
